(19) United States
(12) Patent Application Publication
(10) Pub. No.: US 2002/0166912 A1
(43) Pub. Date: Nov. 14, 2002

(54) Fitting carrier and its use

(75) Inventor: Josef Schneid, Vogt (DE)

Correspondence Address: GREENBLUM & BERNSTEIN, P.L.C., 1941 ROLAND CLARKE PLACE, RESTON, VA, 20191, US

(73) Assignee: Voith Paper Patent GmbH, Heidenheim (DE)

(21) Appl. No.: 10/140,060

(22) Filed: May 8, 2002

(30) Foreign Application Priority Data
May 10, 2001 (DE) 101 22 556.3

(51) Int. Cl. B02C 7/12

(52) U.S. Cl. 241/298

(57) ABSTRACT

Fitting carrier structured to hold at least one fitting in a machine used for the mechanical processing of a paper fiber suspension. The at least one fitting has a front structured for processing suspended fibrous material and a back structured for attachment to the fitting carrier. The fitting carrier includes a base body including a mounting surface and a sound-absorbing layer. The sound-absorbing layer is arranged on the mounting surface.

### CROSS-REFERENCE TO RELATED APPLICATIONS

The present application claims priority under 35 U.S.C. § 119 of German Patent Application No. 101 22 556.3, filed on May 10, 2001, the disclosure of which is expressly incorporated by reference herein in its entirety.

### BACKGROUND OF THE INVENTION

1. Field of the Invention

The present invention relates to a fitting carrier to hold at least one fitting in a machine used for the mechanical processing of a paper fiber suspension. The fitting has a front with an embodiment necessary for processing the suspended fibrous material and a back with which it can be attached to the fitting carrier. The fitting carrier contains a predominantly metallic base body, which has at least one annular or truncated cone-shaped surface for attaching the fitting. Moreover, the present invention relates to a use for the fitting carrier and to a refining disk using this fitting carrier.

2. Discussion of Background Information

Fitting carriers of this type are used to hold fittings used for the mechanical processing of fibrous material suspended in water. This refers primarily to refining paper fibers, dispersing contaminants and fibers and deflaking, i.e., dissolving fiber agglomerates. When grinding in refiners and deflaking, the suspension has a solids content of approximately 2-8%. In the case of machines for higher stock consistencies, they are called, e.g., high consistency grinders, dispersers or kneader pulpers.

Fittings are the working tools for mounting in corresponding processing machines. If they are subjected to greater wear, it has to be possible to replace them at certain intervals. Many fittings feature bridges and grooves on the work surfaces located on the front, which is why they are also called “knife fittings.” Other fittings have the form of toothed rings there.

Form, material and surface of the fittings have a major impact on the processing effect. It is therefore understandable that considerable effort is being devoted to developing fittings, which is reflected in the design of their form and in the choice of material. The emphasis is initially on the fiber technology and energy efficiency. This has led to a number of fittings which are technologically very suitable, but which have the disadvantage of being very noisy in operation.

A method is known from EP 0 922 495 A1 for producing special fittings which differ from conventional fittings in that they are assembled from parts produced separately, namely a base body and a processing element. An elastic bonding material is inserted between these parts. This concerns particularly expensive special fittings which are not made of one homogenous material.

Machines that are provided with fittings of this type have at least one rotor and at least one stator with either disk-shaped or cone-shaped surfaces on which the fittings are mounted by the back so that they each have a relatively large contact surface with the rotor or stator. Such a rotor or stator is thus used as a fitting carrier or contains one or more fitting carriers. As a rule, the fittings are parts subject to regular wear, which therefore have to be easy to replace.

### SUMMARY OF THE INVENTION

The present invention provides fitting carriers of the above-specified type in such a way that the noise level during operation of the processing machines is substantially reduced. Moreover, it should also be possible to attain this feature even when using conventional fittings, particularly those made entirely of metal.

In accordance with the instant invention, the fitting carrier generally discussed above further includes a sound-absorbing layer that, after the fitting has been attached, is located between the fitting and the metallic base body.

A fitting carrier made according to the invention reduces noise generation to a tolerable level, without the actual fittings inevitably having to be altered. However, in special cases a toothed construction on the contact surfaces of the fitting to the sound-absorbing layer can be advantageous, e.g., to increase the precision of positioning.

The present invention is directed to a fitting carrier structured to hold at least one fitting in a machine used for the mechanical processing of a paper fiber suspension. The at least one fitting has a front structured for processing suspended fibrous material and a back structured for attachment to the fitting carrier. The fitting carrier includes a base body including a mounting surface and a sound-absorbing layer. The sound-absorbing layer is arranged on the mounting surface.

According to a feature of the instant invention, the base body can include a predominantly metallic base body and the mounting surface can include at least one annular or truncated cone-shaped surface. Further, when the fitting carrier is in combination with the at least one fitting, the sound-absorbing layer is located between the at least one fitting and the mounting surface.

In accordance with the present invention, the sound-absorbing layer may include an elastic material.

According to another feature of the invention, the sound-absorbing layer may have a thickness of at least about 1 mm.

The sound-absorbing layer can be adhered to the base body. Further, the sound-absorbing layer may be vulcanized. Moreover, the sound-absorbing layer can be adhered to the base body with glue and may be interlocked with glued surfaces by at least one of protrusions and indentations.

The fitting carrier according to the present invention can further include a metal holding plate mounted on the sound-absorbing layer, such that the sound-absorbing layer is located between the holding plate and the mounting surface. The holding plate may be structured and arranged to attach to the back of the at least one fitting. Further, the sound-absorbing layer can be attached by adhesion on both sides. Moreover, the holding plate can include threaded holes structured to receive mounting screws. The at least one fitting can be screwably attached to the holding plate.

According to the instant invention, the fitting carrier may be structured and arranged as one of a rotor and stator in a refiner for refining paper fibers.

Further, the fitting carrier can be structured and arranged as one of a rotor and stator in a deflaker.

Also, the fitting carrier can be structured and arranged as one of a rotor and stator of a disperser.

When the fitting carrier is utilized in combination with the at least one fitting, the sound-absorbing layer and the at least one fitting can include at least one of complementary protrusions and indentions so that the at least one fitting meshes with the sound-absorbing layer.

Moreover, when utilized in combination, the back of the at least one fitting can be in direct contact with the sound-absorbing layer. Further, the fitting carrier and the at least one fitting can be joined by adhesion. Still further, mounting parts can be guided through the sound absorbing layer and can be detachably connectable with a part of the processing machine. The mounting parts can include screws and the part of the processing machine may include one of a rotor and a stator.

The present invention is directed to a process of attaching at least one fitting to a fitting carrier having a base body with a mounting surface. The process includes coupling a sound-absorbing layer on the mounting surface, and coupling the at least one fittings to the sound-absorbing layer.

According to a feature of the invention, the base body can include a predominantly metallic base body and the mounting surface comprises at least one annular or truncated cone-shaped surface. The at least one fitting may be made completely of metal, such as a steel alloy.

According to another feature of the invention, the at least one fitting can be made of ceramic. The at least one fitting may be screwably attached directly to the sound absorbing layer, and the screwable attachment can include sound absorbing washers and bushings.

In accordance with still another feature of the invention, the sound-absorbing layer and the at least one fitting can include at least one of complementary protrusions and indentions, and the process further may further include enmeshing the at least one complementary protrusions and indentations of the at least one fitting and the sound-absorbing layer.

The instant invention is directed to a refining disk including a fitting carrier including a mounting surface and a sound-absorbing layer coupled to the mounting surface, and at least one processing plate having a mounting portion coupled to the sound-absorbing layer and a processing portion structured for processing suspended fibrous material.

In accordance with the instant invention, the mounting surface can include a disk surface having a diameter that corresponds to an outer diameter of the sound absorbing layer. The disk surface can include a predominantly metal disk. Further, the at least one processing plate can be formed of ceramic material, and the at least one processing plate can be coupled directly to the sound-absorbing layer.

The processing plate can be connected to the sound-absorbing layer without piercing mounting parts.

Further, the processing plate may include strips structured and arranged for use in a refiner for at least one of paper or cellulose production.

According to still another feature of the present invention, the processing plate can include axially protruding toothed rows structured and arranged for use in a at least one of disperser or deflaker for at least one of paper or cellulose production.

According to another feature of the invention, the refining disk can be structured and arranged as rotor.

In accordance with yet another feature of the present invention, the refining disk can be structured and arranged as a stator.

Other exemplary embodiments and advantages of the present invention may be ascertained by reviewing the present disclosure and the accompanying drawing.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 illustrates a sectional side view of a fitting carrier with a mounted fitting;

FIG. 2 illustrates a plan view of a fitting carrier with knife fitting;

FIG. 3 illustrates a sectional side view of a fitting carrier with mounted toothed ring fitting;

FIG. 4 illustrates a sectional side view of a varied fitting carrier with mounted fitting; and

FIG. 5 illustrates a special refining disk in accordance with the instant invention.

### DETAILED DESCRIPTION OF THE PRESENT INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

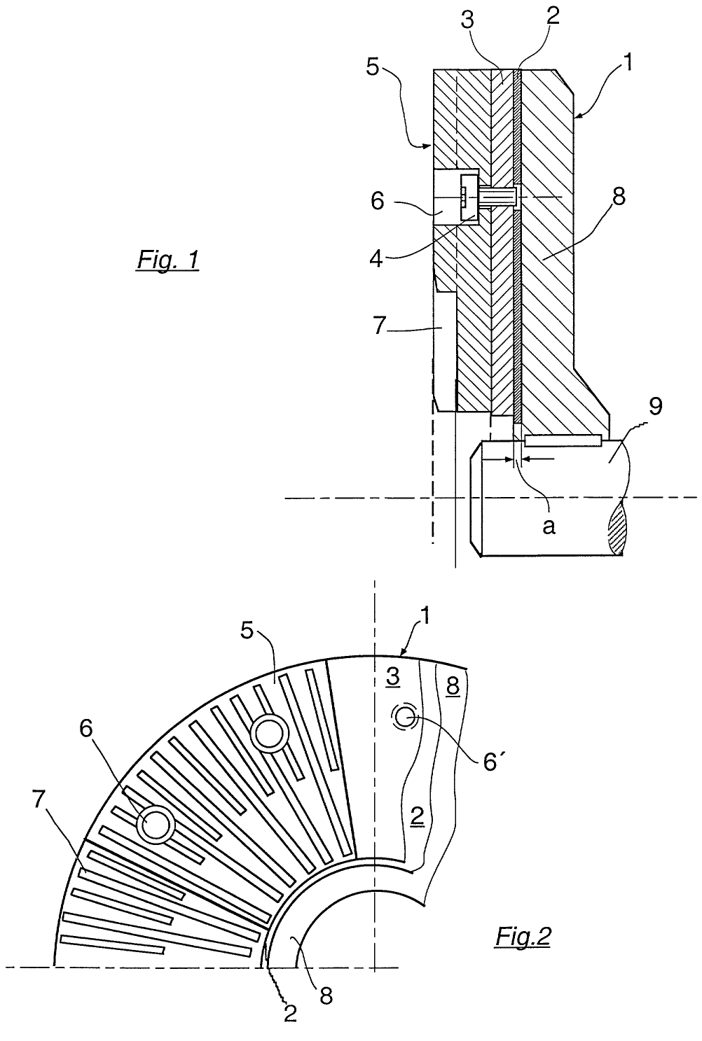

FIG. 1 shows in side view a fitting carrier 1 with mounted fitting 5, which are arranged to form a processing element. To process the suspended fibrous material, the front of fitting 5 is provided with strips 7 of different lengths. The shorter strips are drawn in section. Strips 7 of the processing element project, form a refining fitting that is known per se as a “knife fitting.” Fitting 5 is detachably fixed at the back by mounting screws 4 guided through holes 6 into a holding plate 3. Holding plate 3 is part of fitting carrier 1. Moreover, sound-absorbing layer 2 is located between holding plate 3 and a base body 8, e.g., a metallic body, in the form of a rotor disk, which is driven by shaft 9. Sound-absorbing layer 2 is bonded on both sides and prevents the noise produced during operation at fittings 5 from being transferred to base body or rotor 8 as solid-borne noise. The counter-fitting (not drawn), which is, in generally, formed a stator fitting, is likewise to be fastened to a fitting carrier provided with a sound-absorbing layer. The rotor and stator are rigid and are pressed together by at least one slip fit. Thus, fitting 5, once attached, is made of one homogenous material, e.g., chromium steel. Such fittings can become very noisy in operation, depending on the alignment of strips 7, if they are in direct contact with the metallic base body.

FIG. 2 shows in plan view similar fittings 5 to those depicted in FIG. 1 with a partially covered fitting carrier 1. This representation is also only diagrammatic. Fittings 5 have the shape of circular ring segments, which, in turn, hold strips 7, which in the illustrated embodiment are straight and in part of different lengths. It is also conceivable to utilize curved strips. Layer 2, holding plate 3 and rotor disk 8 are drawn in part uncovered and thus visible. One of threaded holes 6′ for mounting screw 4 can be seen in holding plate 3.

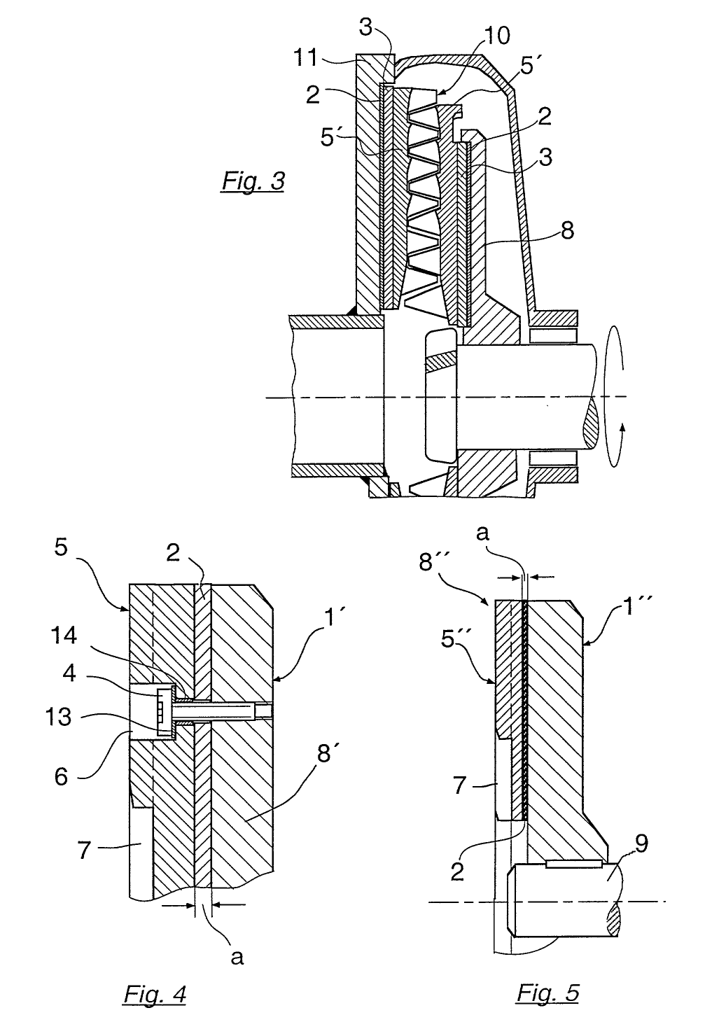

The fitting carriers shown in FIG. 3 are for installing in a disperser. The fittings used in such a machine are known to feature axially interlocking concentric toothed rows 10. When dispersers are operating, there is a considerable noise problem which can be solved in accordance with the features of the present invention. As illustrated, the disperser includes stator 11 and holding plate 3, both of which include sound-absorbing layer 2. Other apparatuses which use similar type fittings can benefit from the instant invention. For example, deflakers are also provided with fittings, the front of which contains a number of interlocking toothed rows. Although the hydraulic conditions in deflakers and dispersers are different, the use of the invention is essentially the same. This therefore concerns only an exemplary embodiment of toothed ring fittings, such as are used in dispersers or deflakers.

With fitting carrier 1′ shown in FIG. 4, mounting screw 4 is anchored, not in a holding plate, but directly into rotor disk 8. This is less expensive, and sound-absorbing layer 2 is exposed to less strain from circumferential forces. While there is a danger of sound transmission occurring through mounting screws 4, this can be remedied with sound-absorbing washers 13 and bushings 14 in screw holes 6.

Today it is possible to produce fittings which have an extremely high durability in normal operation with the help of high-grade ceramic materials. Such materials are, e.g., also known from EP 0 922 495 A1, as already mentioned. If it is possible to do without a quick change of fittings, it may be useful to adhere or vulcanize the ceramic fitting part as a processing plate 5″ directly onto sound-absorbing layer 2 in accordance with the embodiment depicted in FIG. 5. Then the refining rotor or refining stator is a finished refining disk 8″ made of one piece. In addition to the advantage of a lower number of individual parts, the screw holes in the fittings can be dispensed with, which otherwise are known to lead to a highly undesirable loss of refining surface. In the event of an exceptional damage to the fitting, the rotor or stator would then need to be completely exchanged and reconditioned in a special workshop (exchange part). The same applies to disperser and deflaker machines.

It is noted that the foregoing examples have been provided merely for the purpose of explanation and are in no way to be construed as limiting of the present invention. While the present invention has been described with reference to an exemplary embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

What is claimed:

1. A fitting carrier structured to hold at least one fitting in a machine used for the mechanical processing of a paper fiber suspension, the at least one fitting having a front structured for processing suspended fibrous material and a back structured for attachment to said fitting carrier, said fitting carrier comprising:
a base body comprising a mounting surface; and
a sound-absorbing layer,
wherein said sound-absorbing layer is arranged on said mounting surface.

2. The fitting carrier in accordance with claim 1, wherein said base body comprises a predominantly metallic base body and said mounting surface comprises at least one annular or truncated cone-shaped surface.

3. The fitting carrier in accordance with claim 2 in combination with the at least one fitting, wherein said sound-absorbing layer is located between said at least one fitting and said mounting surface.

4. The fitting carrier in accordance with claim 1, wherein said sound-absorbing layer comprises an elastic material.

5. The fitting carrier in accordance with claim 1, wherein said sound-absorbing layer has a thickness of at least about 1 mm.

6. The fitting carrier in accordance with claim 1, wherein said sound-absorbing layer is adhered to said base body.

7. The fitting carrier in accordance with claim 6, wherein said sound-absorbing layer is vulcanized.

8. The fitting carrier in accordance with claim 6, wherein said sound-absorbing layer is adhered to said base body with glue and is interlocked with glued surfaces by at least one of protrusions and indentations.

9. The fitting carrier in accordance with claim 1, further comprising a metal holding plate mounted on said sound-absorbing layer, whereby said sound-absorbing layer is located between said holding plate and said mounting surface.

10. The fitting carrier in accordance with claim 9, wherein said holding plate is structured and arranged to attach to the back of the at least one fitting.

11. The fitting carrier in accordance with claim 9, wherein said sound-absorbing layer is attached by adhesion on both sides.

12. The fitting carrier in accordance with claim 9, wherein said holding plate comprises threaded holes structured to receive mounting screws.

13. The fitting carrier in accordance with claim 12, wherein the at least one fitting is screwably attached to said holding plate.

14. The fitting carrier in accordance with claim 1, wherein said fitting carrier is structured and arranged as one of a rotor and stator in a refiner for refining paper fibers.

15. The fitting carrier in accordance with claim 1, wherein said fitting carrier is structured and arranged as one of a rotor and stator in a deflaker.

16. The fitting carrier in accordance with claim 1, wherein said fitting carrier is structured and arranged as one of a rotor and stator of a disperser.

17. The fitting carrier in accordance with claim 1 in combination with the at least one fitting, wherein said sound-absorbing layer and the at least one fitting comprise at least one of complementary protrusions and indentions so that the at least one fitting meshes with said sound-absorbing layer.

18. The fitting carrier in accordance with claim 1 in combination with the at least one fitting, wherein the back of the at least one fitting is in direct contact with said sound-absorbing layer.

19. The combination fitting carrier and at least one fitting in accordance with claim 18, wherein said fitting carrier and the at least one fitting are joined by adhesion.

20. The combination fitting carrier and at least one fitting in accordance with claim 18, wherein mounting parts are guided through said sound absorbing layer and are detachably connectable with a part of the processing machine.

21. The combination fitting carrier and at least one fitting in accordance with claim 20, wherein said mounting parts comprise screws and said part of the processing machine comprises one of a rotor and a stator.

22. A process of attaching at least one fitting to a fitting carrier having a base body with a mounting surface, said process comprising:
coupling a sound-absorbing layer on said mounting surface; and
coupling the at least one fittings to said sound-absorbing layer.

23. The process in accordance with claim 22, wherein said base body comprises a predominantly metallic base body and said mounting surface comprises at least one annular or truncated cone-shaped surface.

24. The process in accordance with claim 23, wherein the at least one fitting is made completely of metal.

25. The process in accordance with claim 24, wherein the metal comprises a steel alloy.

26. The process in accordance with claim 23, wherein the at least one fitting is made of ceramic.

27. The process in accordance with claim 26, wherein said at least one fitting is screwably attached directly to the sound absorbing layer.

28. The process in accordance with claim 27, wherein the screwable attachment includes sound absorbing washers and bushings.

29. The process in accordance with claim 22, wherein the sound-absorbing layer and the at least one fitting comprise at least one of complementary protrusions and indentions, and said process further comprises enmeshing the at least one complementary protrusions and indentations of the at least one fitting and the sound-absorbing layer.

30. The process in accordance with claim 22, wherein the sound-absorbing layer is adhered to the base body.

31. The process in accordance with claim 30, wherein the sound-absorbing layer is vulcanized.

32. The process in accordance with claim 30, wherein the sound-absorbing layer is adhered to the base body with glue and is interlocked with glued surfaces by at least one of protrusions and indentations.

33. The process in accordance with claim 30, wherein the mounting portion of the at least one fitting is in direct contact with the sound-absorbing layer.

34. The process in accordance with claim 22, wherein the fitting carrier is screwably connected directly to the sound-absorbing layer.

35. The process in accordance with claim 22, further comprising mounting a metal holding plate on the sound-absorbing layer, whereby the sound-absorbing layer is located between the holding plate and the mounting surface.

36. The process in accordance with claim 35, wherein the holding plate is structured and arranged to attach to a mounting portion of the at least one fitting.

37. The process in accordance with claim 35, wherein the sound-absorbing layer is attached by adhesion on both sides.

38. The process in accordance with claim 35, further comprising screwably attaching the at least one fitting to the holding plate.

39. A refining disk comprising:
a fitting carrier comprising a mounting surface and a sound-absorbing layer coupled to said mounting surface;
at least one processing plate having a mounting portion coupled to said sound-absorbing layer and a processing portion structured for processing suspended fibrous material.

40. The refining disk in accordance with claim 39, wherein said mounting surface comprises a disk surface having a diameter that corresponds to an outer diameter of said sound absorbing layer.

41. The refining disk in accordance with claim 40, wherein said disk surface comprises a predominantly metal disk.

42. The refining disk in accordance with claim 41, wherein said at least one processing plate is formed of ceramic material.

43. The refining disk in accordance with claim 41, wherein said at least one processing plate is coupled directly to said sound-absorbing layer.

44. The refining disk in accordance with claim 39, wherein said processing plate is connected to said sound-absorbing layer without piercing mounting parts.

45. The refining disk in accordance with claim 39, wherein said processing plate comprises strips structured and arranged for use in a refiner for at least one of paper or cellulose production.

46. The refining disk in accordance with claim 39, wherein said processing plate comprises axially protruding toothed rows structured and arranged for use in a at least one of disperser or deflaker for at least one of paper or cellulose production.

47. The refining disk in accordance with claim 39, wherein said refining disk is structured and arranged as rotor.

48. The refining disk in accordance with claim 39, wherein said refining disk is structured and arranged as a stator.
